(19) United States
(12) Patent Application Publication
(10) Pub. No.: US 2003/0120428 A1
(43) Pub. Date: Jun. 26, 2003

(54) Prediction method of the effect of radiotherapy for cancer patients

(75) Inventors: Masaki Mori, Beppu-shi (JP); Keizo Sugimachi, Fukuoka-shi (JP); Yoichi Tanaka, Tokyo (JP); Kenji Shibuta, Beppu-shi (JP); Hiroshi Inoue, Ooita-shi (JP); Ayumi Matsuyama, Beppu-shi (JP)

Correspondence Address: ARMSTRONG,WESTERMAN & HATTORI, LLP, 1725 K STREET, NW, SUITE 1000, WASHINGTON, DC, 20006, US

(73) Assignee: PHARMADESIGN, INC., Tokyo (JP)

(21) Appl. No.: 10/207,791

(22) Filed: Jul. 31, 2002

(30) Foreign Application Priority Data
Dec. 19, 2001 (JP) 2001-386712

(51) Int. Cl. G06F 19/00

(52) U.S. Cl. 702/19

(57) ABSTRACT

A method of predicting the effectiveness of radiotherapy for cancer patients. A method of predicting the effectiveness of radiotherapy for cancer patients, which includes the steps of: (a) performing a biopsy to collect cancer cells or cancer tissues from a cancer patient, (b) determining the expression level of hepatoma derived growth factor (HDGF) in the cancer cells or cancer tissues obtained in step (a), and (c) on the basis of the results obtained by the determination in step (b), predicting whether or not a significant treatment effect can be obtained when radiotherapy is carried out on the cancer patient.

### BACKGROUND OF THE INVENTION

1. Field of the Invention

The present invention relates to a prediction method of the effect of radiotherapy for cancer patients (especially esophageal cancer patients).

2. Description of the Related Art

Radiotherapy for cancer is a treatment that applies high energy X-rays in order to cause damage to cancer cells and control growth and proliferation thereof. Radiotherapy is a useful method of treating many kinds of cancers located on almost all sites in the body, and about half of all cancer patients undergo radiotherapy. However, where radiotherapy is carried out on a cancer patient, it does not only cause damage to cancer cells so as to produce a life-prolonging effect, but exerts damage even on normal cells. As a result, the patient suffers from side effects such as nausea, anorexia, cardiopathy, alopecia, myelopathy, encephalopathy, bleeding tendency and immunodeficiency. There exist many patients who have experienced only a low treatment effect of treatment with radiotherapy, while they greatly suffer from side effects. For such patients, it is extremely important that the effect of radiotherapy is predicted before treatment and when a significant effect cannot be expected, treatments other than radiotherapy are applied, so as to enhance the quality of life (QOL) of patients. However, presently, an effective method of predicting the effect of radiotherapy before treatment is still unknown.

It is the object of the present invention to provide a method of predicting before treatment whether or not a significant treatment effect can be obtained when radiotherapy is carried out on a cancer patient (especially an esophageal cancer patient), or the like.

### SUMMARY OF THE INVENTION

As a result of intensive studies directed towards the above object, the present inventors have found that cancer patients having a high expression level of hepatoma derived growth factor (HDGF) in cell tissues show high effectiveness for radiotherapy. Then, the present inventors have succeeded in predicting the effectiveness of radiotherapy before treatment by examining the expression level of HDGF in the cancer tissues of a cancer patient, thereby completing the present invention.

That is to say, the present invention includes the following (1) to (15):

(1) A method of predicting the effectiveness of radiotherapy for cancer patients, which comprises the steps of:

(a) performing a biopsy to collect cancer cells or cancer tissues from a cancer patient,

(b) determining the expression level of hepatoma derived growth factor (HDGF) in the cancer cells or cancer tissues obtained in step (a), and

(c) on the basis of the results obtained by the determination in step (b), predicting whether or not a significant treatment effect can be obtained when radiotherapy is carried out on the above cancer patient.

(2) The method of predicting the effectiveness of radiotherapy for cancer patients according to (1) above, wherein the prediction as to whether or not a significant treatment effect can be obtained when radiotherapy is carried out on a cancer patient is performed on the basis of the prediction standard that a significant treatment effect can be obtained when the expression level of hepatoma derived growth factor (HDGF) is high, but a significant treatment effect cannot be obtained when the expression level is low.

(3) The method of predicting the effectiveness of radiotherapy for cancer patients according to (1) above, wherein the determination of the expression level is carried out at the mRNA level or protein level.

(4) The method of predicting the effectiveness of radiotherapy for cancer patients according to (1) above, wherein the determination of the expression level is carried out using a DNA chip or protein chip.

(5) The method of predicting the effectiveness of radiotherapy for cancer patients according to (1) above, wherein the hepatoma derived growth factor (HDGF) is represented by the amino acid sequence of SEQ ID NO: 2 or encoded by DNA represented by the nucleotide sequence of SEQ ID NO: 1.

(6) The method of predicting the effectiveness of radiotherapy for cancer patients according to (1) above, wherein the cancer patient is an esophageal cancer patient.

(7) A method of predicting the effectiveness of radiotherapy for cancer patients, which further comprises a step of determining the expression level of a housekeeping gene or housekeeping protein in addition to the steps described in (1) above, and predicts whether or not a significant treatment effect can be obtained when radiotherapy is carried out on a cancer patient on the basis of the relative ratio of the mRNA level of an HDGF gene to the mRNA level of the housekeeping gene or the relative ratio of the protein level of HDGF protein to the protein level of the housekeeping protein, which is calculated based on the results obtained by the determination.

(8) The method of predicting the effectiveness of radiotherapy for cancer patients according to (7) above, wherein the housekeeping gene or protein is a glyceraldehyde-3-phosphate dehydrogenase (GAPDH) gene or protein.

(9) The method of predicting the effectiveness of radiotherapy for cancer patients according to (8) above, wherein the prediction as to whether or not a significant treatment effect can be obtained when radiotherapy is carried out on a cancer patient is performed on the basis of the prediction standard that a significant treatment effect can be obtained when the mRNA level of the HDGF gene/the mRNA level of the GAPDH gene is higher than 1.14, but a significant treatment effect cannot be obtained when the mRNA level of the HDGF gene/the mRNA level of the GAPDH gene is lower than 1.14.

(10) A reagent used for predicting the effectiveness of radiotherapy for cancer patients, which comprises, as a functional ingredient, polynucleotide, oligonucleotide or a derivative thereof, which hybridizes with the mRNA of hepatoma derived growth factor (HDGF) under stringent conditions.

(11) A reagent used for predicting the effectiveness of radiotherapy for cancer patients, which comprises, as a functional ingredient, an antibody against hepatoma derived growth factor (HDGF).

(12) A kit used for predicting the effectiveness of radiotherapy for cancer patients, which comprises, as a main component, the prediction reagent according to (10) above and/or (11) above.

(13) A DNA chip used for predicting the effectiveness of radiotherapy for cancer patients, which is obtained by immobilizing polynucleotide or oligonucleotide, which hybridizes with the mRNA of hepatoma derived growth factor (HDGF) or a complementary strand thereof under stringent conditions.

(14) A protein chip used for predicting the effectiveness of radiotherapy for cancer patients, which is obtained by immobilizing an antibody against hepatoma derived growth factor (HDGF).

(15) A method of screening a compound enhancing a treatment effect when radiotherapy is carried out on a cancer patient, the above screening method comprising a step of evaluating whether or not the expression level of hepatoma derived growth factor (HDGF) in a human cell is increased by addition of a candidate compound, wherein the activity of enhancing the above expression level is the index of a candidate compound which can be an enhancer for the effectiveness of radiotherapy.

### BRIEF DESCRIPTION OF THE DRAWINGS

FIG. 1 is a view showing the results of differential display of three types of esophageal cancer cell lines.

FIG. 2 is a view showing the interrelationship between RSG1 and HDGF, and the position of each primer used in Examples.

FIG. 3 is a view showing the results of semiquantitative RT-PCR on an RSG1 gene and an HDGF gene.

FIG. 4 is a view showing the results of Northern Blotting for an HDGF gene.

FIG. 5 is a view showing the results of RT-PCR on an HDGF gene and a bFGF gene.

FIG. 6 is a view showing the results of semiquantitative RT-PCR, which show the expression level of an HDGF gene and a GAPDH gene in the cancer tissues of an esophageal cancer patient.

### DETAILED DESCRIPTION OF THE PREFERRED ENBODIMENTS

The present invention will be explained in detail below.

The present invention relates to a method of predicting the effectiveness of radiotherapy for cancer patients (hereinafter, simply referred to as an effectiveness prediction method at times), in which the expression level of hepatoma derived growth factor (HDGF) is used as an index. Specifically, this method can be carried out as follows.

To be specific, HDGF which is the target of determination in the present invention is heparin-binding protein having a molecular weight of about 25 kDa, which is extracted as protein having a mitogenic activity for Swiss 3T3 cells from the culture supernatant of cultured cells of a human hepatoma-derived cell line HuH-7 (Nakabayashi, H., Taketa, K., Miyano, K., Yamane, T. and Sato, J.: Cancer Res., 42: 3858-3863 (1982)). The HDGF gene has already been cloned (Nakamura, H., Izumoto, Y., Kambe, H., Kuroda, T., Mori, T., Kawamura, K., Yamamoto, H., and Kishimoto, T., J. Biol. Chem., 269:25143-25149 (1994); Japanese Patent Application Laid-Open (Kokai) No. 6-220094). The nucleotide sequence of HDGF is shown in SEQ ID NO: 1, and the amino acid sequence of HDGF encoded by the above nucleotide sequence is shown in SEQ ID NO: 2. In the effectiveness prediction method of the present invention, it is important to determine the expression level of HDGF in cancer cells or cancer tissues derived from a cancer patient, and this is a feature of the present invention.

In the effectiveness prediction method of the present invention, initially, a biopsy is carried out to collect cancer cells or cancer tissues from a cancer patient. The “biopsy” is referred to also as exploratory incision, and this means that a portion of vital tissues or organs is collected and examined pathologically to confirm diagnosis or determine the progression or prognosis of disease. Examples of such a biopsy include an aspiration biopsy in which a puncture needle is used, a surgical biopsy in which surgical incision is performed to collect a small section, etc., and the biopsy can be carried out using an apparatus such as a reusable puncture instrument, AutoClicks-P (Roche Diagnostics).

Subsequently, the expression level of HDGF in the obtained cancer cells or cancer tissues is determined. The determination of the expression level can be carried out at mRNA or protein level. The determination of the expression level at mRNA level can be carried out by the well-known RT-PCR (Reverse Transcribed-Polymerase Chain Reaction; Kawasaki, E. S., et al., Amplification of RNA. In PCR Protocol, A Guide to methods and applications, Academic Press, Inc., Dan Diego, 21-27 (1991)). A multiple number of techniques of the determination of the expression level at mRNA level are known other than the RT-PCR (e.g. the Northern Blotting method, the NASBA method, a method of using a DNA chip, etc.), and in the present invention, any method selected from among various known methods can be applied in such an extent that the mRNA level of HDGF can be determined by the method. In the determination of the expression level at mRNA level, according to a conventional method, total RNA or poly A(+) RNA is extracted, purified and prepared from test cells or test tissues, as necessary, to use for the determination of the expression level.

Where RT-PCR is applied for the determination of mRNA level of an HDGF gene contained in a sample, any primer may be used in such an amount that it can specifically amplify only the mRNA of the HDGF gene, and the region that the primer amplifies, the nucleotide length or the like is not limited. This primer can be an oligonucleotide that hybridizes with cDNA prepared from the mRNA of an HDGF gene under stringent conditions and has a sequence consisting of about 15 to 30 nucleotides. Such a primer can be designed according to a conventional method. A preferred example of designing the primer is shown in Examples described later.

Where the Northern Blotting analysis is applied for the determination of mRNA level of an HDGF gene contained in a sample, any probe for detection may be used in such an extent that it can specifically hybridizes with the mRNA of an HDGF gene. Accordingly, a probe used is not particularly limited, as long as it hybridizes with the mRNA of an HDGF gene under stringent conditions and has specificity that enables detection under detection conditions applied for hybridization with a test RNA sample. Examples of such a probe include: a polynucleotide or oligonucleotide comprising the complementary strand of the nucleotide sequence shown in SEQ ID NO: 1 that is the open reading frame (ORF) portion of an HDGF gene, or a portion thereof; a polynucleotide or oligonucleotide comprising the complementary strand of the nucleotide sequence shown in SEQ ID NO: 3 that comprises the 5′-upstream or 3′-downstream nontranslated regions of the ORF of an HDGF gene, or a portion thereof; a restriction enzyme fragment thereof; an oligonucleotide chemically synthesized according to the nucleotide sequence of an HDGF gene; etc.

The term “stringent conditions” is herein used to specifically mean the conditions that hybridization is carried out with 6×SSC, 40% formamide, at 37° C. and washing is carried out with 0.2×SSC at 55° C. It is expected that a polynucleotide or oligonucleotide having higher homology can more efficiently be obtained, as temperature is increased in the above conditions. Multiple elements including salt concentration are considered to have an effect on the stringency of hybridization, and a person skilled in the art can realize the stringency by selecting appropriate elements. The above-described primer and probe can be converted into a derivative by fluorescent labeling or radioactive labeling. These primers and probes can be used as a functional ingredient of a reagent of predicting the effectiveness of radiotherapy for cancer patients. An effective prediction reagent having the above-described primer and probed as functional ingredients can also be used as a main component of a kit of predicting the effectiveness of radiotherapy for cancer patients. Moreover, the above-described probes can also be used as a capture probe for capturing the mRNA of an HDGF gene or cDNA or cRNA derived from the mRNA, when a DNA chip for predicting the effectiveness of radiotherapy for cancer patients is prepared. Methods of preparing a DNA chip are known to those skilled in the art.

Various operations performed in the effectiveness prediction method of the present invention, i.e., any of enzyme treatment, isolation, purification, replication, selection, etc., which is performed for the purpose of chemical synthesis, cleavage, deletion, addition or binding of some genes, can be carried out according to a conventional methods (e.g. refer to “Bunshi Idengaku Jikken Ho (Experimental Method of Molecular Genetics)”, Kyoritsu Shuppan Co., Ltd., 1983; “PCR Technology”, Takara Shuzo Co., Ltd., 1990; etc.) For example, the above-described isolation and purification can be carried out by agarose gel electrophoresis or the like. The obtained polynucleotides can be sequenced according to e.g. the dideoxy method (Proc. Natl. Acad. Sci., U.S.A, 74: 5463-5467 (1977)) or the Maxam-Gilbert method (Method in Enzymology, 65: 499-560 (1980), and further, such nucleotide sequence determination can easily be carried out also using a commercially available sequence kit or the like. The conditions for PCR can also be set according to standard techniques (e.g. refer to Science, 230: 1350-1354 (1985), etc.)

The determination of the expression level at protein level can be carried out by immunoassay (e.g. ELISA etc.), in which a specific antibody against HDGF is used. Several techniques of determining the expression level at protein level are known other than ELISA (e.g. a method of using a protein chip, etc.), and any method selected from among various known methods can be applied in such an extent that the protein level of HDGF can be determined by the method. Herein, a specific antibody against HDGF protein can be produced according to a conventional method, using HDGF protein or a partial peptide thereof as an immunogen. The above-described antibody can be converted into a derivative by enzyme labeling or radioactive labeling. The above-described antibody can be used as a functional ingredient of a reagent of predicting the effectiveness of radiotherapy for cancer patients. The effectiveness prediction reagent having the above-described antibody as a functional ingredient, can also be used as a main component of a kit of predicting the effectiveness of radiotherapy for cancer patients. Moreover, the above-described antibody can also be used as a molecule for capturing HDGF, when a protein chip of predicting the effectiveness of radiotherapy for cancer patients is prepared. The method of preparing a protein chip is known to a person skilled in the art.

Subsequently, on the basis of the results obtained by the determination of the expression level, it is predicted whether or not a significant effect can be obtained when radiotherapy is carried out on a cancer patient (especially an esophageal cancer patient). That is to say, where the obtained expression level is higher than the expression level in normal cells or the body of a healthy person, it can be predicted that a significant treatment effect can be obtained (or likely to be obtained), but where the obtained expression level is lower, it can be predicted that a significant treatment effect cannot be obtained. Moreover, it is one preferred embodiment of the present invention that the mRNA level of a housekeeping gene or the protein level of housekeeping protein is also determined as an internal standard, and then the expression level of HDGF is evaluated on the basis of the relative ratio of the mRNA level of an HDGF gene to the mRNA level of the housekeeping gene or the relative ratio of the protein level of HDGF protein to the protein level of the housekeeping protein, so that variations in the sample extraction efficiency among cells or tissues are reduced in the evaluation of the HDGF expression level. An example of the housekeeping gene or protein includes a glyceraldehyde-3-phosphate dehydrogenase (GAPDH) gene or protein. Where the GAPDH gene is used as an internal standard, the prediction as to whether or not a significant treatment effect can be obtained when radiotherapy is carried out on a cancer patient is performed on the basis that a significant treatment effect can be obtained (or likely to be obtained) when the mRNA level of the HDGF gene/the mRNA level of the GAPDH gene is higher than 1.14, but a significant treatment effect cannot be obtained when the mRNA level of the HDGF gene/the mRNA level of the GAPDH gene is lower than 1.14. Thus, according to the present invention, it is possible to predict the effect of radiotherapy for a cancer patient before treatment. This is extremely useful for the selection of treatment methods for each patient, and thereby it can contribute to a tailor-made treatment for cancer.

As stated above, according to the present invention, it is found that the significant effect of radiotherapy can be obtained when the expression level of an HDGF gene is high, but the significant effect of radiotherapy cannot be obtained when the expression level of the gene is low. Based on this result, in one embodiment of the present invention, there is provided a method of screening a compound which enhances a treatment effect when radiotherapy is carried out on a cancer patient. Specifically, it is possible to screen a candidate compound by adding the candidate compound to a human cell (e.g. a cultured human cell) and examining whether or not the expression level of HDGF in the human cell increases. As described above, where the expression level of HDGF is increased by the addition of a candidate compound, it can be evaluated that the compound could have an activity of enhancing the treatment effect of radiotherapy.

### EXAMPLES

The present invention will further be described in the following examples. However, the examples are provided for illustrative purposes only, and are not intended to limit the scope of the invention.

### Example 1

Establishment of Cell Lines Resistant to Irradiation

Cell lines resistant to irradiation were established, using human esophageal cancer-derived cell lines. Using an X-ray generator MBR-1505R (Hitachi Medical), cell lines derived from human squamous esophageal cancer cells, TE-2, TE-3, TE-9, TE-11 and TE-13 provided from the Cell Resource Center for Biomedical Research, the Institute of Development, Aging and Cancer, Tohoku University, and human esophageal cancer cell lines, KYSE 110 and KYSE410 furnished from Dr. Shimada, Kyoto University, were treated repetitively by 2 Gy of X-ray irradiation (100 kV, 3.5 mA, 5 minutes) every 2 weeks. Only three types of cell lines, TE-11, TE-13 and KYSE410 survived this challenge as cell lines resistant to irradiation.

Subsequently, the sensitivity of these three types of cell lines to X-ray irradiation was examined by determining the frequency rate of apoptosis when a higher dose of X-ray was applied. That is, initially, 10 Gy of X-ray was once applied to both TE-11, TE-13 and KYSE410, which were treated totally 15 times by pre-irradiation with 2 Gy of X-ray (i.e. treated by pre-irradiation with a total of 30 Gy of X-ray), and TE-11, TE-13 and KYSE410, which were not treated by X-ray irradiation. Then, the cells treated by X-ray irradiation were stained with APO 2.7 (Immunotech), which is an antibody against mitochondrial membrane protein, followed by examination with FACScan (Becton Dickinson). Table 1 shows the results of comparison analysis of the apoptosis induced after 10 Gy of X-ray irradiation.

TABLE 1

Rate of cells going into apoptosis (%)^{a}

| Cell line | 10 h | 24 h | 48 h |
|---|---|---|---|
| TE-11 | | | |
| C | 17.6 ± 2.6^{b} | 3.4 ± 1.0 | 7.6 ± 1.9 |
| R15 | 0.7 ± 0.2^{b} | 7.5 ± 1.7 | 4.2 ± 1.5 |
| TE-13 | | | |
| C | 6.7 ± 1.9 | 1.7 ± 1.1 | 17.9 ± 1.4^{c} |
| R15 | 5.8 ± 2.8 | 2.0 ± 0.6 | 1.2 ± 0.4^{c} |
| KYSE410 | | | |
| C | 3.7 ± 1.3 | 1.8 ± 0.8 | 17.4 ± 1.9^{d} |
| R15 | 5.4 ± 1.6 | 1.9 ± 1.0 | 2.4 ± 1.6^{d} |

^{a}Average ± SD,
^{b}P = 0.005,
^{c}P = 0.002,
^{d}P = 0.0001,
C: Control parent cells,
R15: cells treated 15 times by 2 Gy of X-ray pre-irradiation

That is to say, as shown in Table 1, in the case of TE-11, the rate of cells going into apoptosis 10 hours after 10 Gy of X-ray irradiation, was 17.60±2.61% in the cell lines (C) which were not treated by X-ray pre-irradiation, but 0.73±0.21% in the cell lines (R15) which were treated by X-ray pre-irradiation. Moreover, in the case of TE-13, the rate of cells going into apoptosis 48 hours after 10 Gy of X-ray irradiation was, 17.90±1.47% in the cell lines (C) which were not treated by X-ray pre-irradiation, but 1.20±0.36% in the cell lines (R15) which were treated by X-ray pre-irradiation. Furthermore, in the case of KYSE410, the rate of cells going into apoptosis 48 hours after 10 Gy of X-ray irradiation was, 17.40±1.95% in the cell lines (C) which were not treated by X-ray pre-irradiation, but 2.43±1.64% in the cell lines (R 15) which were treated by X-ray pre-irradiation. Thus, in cell lines treated by X-ray pre-irradiation, the rate of cells going into apoptosis was reduced when compared with parent cell lines which were non treated by the pre-irradiation, and accordingly it was found that the acquisition of irradiation resistance is reflected in the frequency rate of apoptosis.

### Example 2

Difference of Expressed Genes Between Irradiation Resistant Cell Lines and Parent Cell Lines

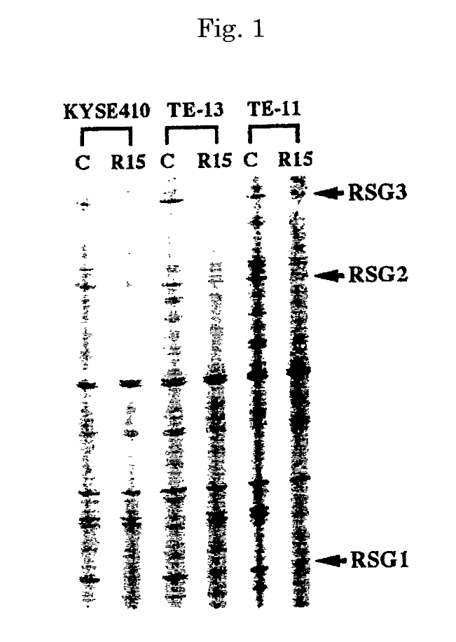

The three types of cell lines (TE-11, TE-13 and KYSE410), which were found to acquire irradiation resistance by multiple times of irradiation exposure in Example 1, were examined regarding the difference of expressed genes between before and after the acquisition of irradiation resistance. That is, differential display was carried out according to a conventional method. The PCR products obtained by the differential displays were electrophoresed. The band pattern obtained after electrophoresis is shown in FIG. 1. Each lane displayed about 50 bands. Most bands showed the same band pattern between before (C in FIG. 1) and after (R15 in FIG. 1) the acquisition of irradiation resistance in all of the three types of cell lines. However, several bands disappeared or were reduced simultaneously with the acquisition of irradiation resistance. As shown in FIG. 1, those cDNA bands were named as RSG 1, RSG2 and RSG3 from the short strand side. Then, cDNA was reamplified from the band of RSG1. The size of the DNA fragment was about 300-bp. Further, the RT-PCR was carried out to confirm that the expression of RSG1 was reduced after the acquisition of irradiation resistance, when compared with before the acquisition of the resistance.

### Example 3

Identification of Gene Having Reduced Expression Level after Acquisition of Irradiation Resistance

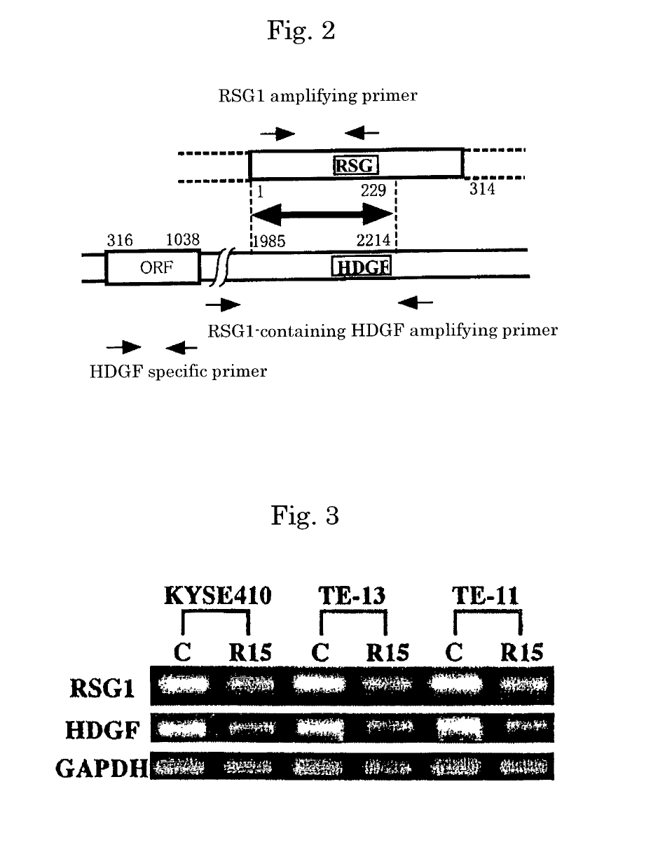

The band of RSG1 obtained in Example 2 was cut out from the gel, and the DNA was extracted and cloned by the TA cloning method (Invitrogen). After that, the nucleotide sequence of the cloned DNA fragment was determined using an ABI PRISM 377 DNA sequencing system (Applied Biosystems). The determined nucleotide sequence is shown in SEQ ID NO: 4. Subsequently, when a search was made against gene database GenBank, using the BLAST homology program, wherein the determined nucleotide sequence was used as a query, it was found that the nucleotide sequence of RSG1 was completely matched with a part of the nucleotide sequence of a human hepatoma derived growth factor (HDGF) gene, in the region shown in FIG. 2. It should be noted that, in FIG. 2, the numbers shown on a bar representing the ORF of an HDGF gene, represent the numbers of nucleotides in the case where the first nucleotide of SEQ ID NO: 3 is defined as 1.

Subsequently, using the following primers for amplification of the sequence of RSG1:

5′-CTTCTATTTGGGGCTTGATGAC-3′ (SEQ ID NO: 5) as a sense primer, and

5′-GCACTTATTTCTCTCGGTCCTC-3′ (SEQ DI NO: 6) as an antisense primer,

and further, using the following primers for an HDGF gene containing the RSG1 sequence:

5′-CTGAAGCCACAAATAGGATG-3′ (SEQ ID NO: 7) as a sense primer, and

5′-GGGTAAAAGAGACGAGACTG-3′ (SEQ ID NO: 8) as an antisense primer,

semiquantitative RT-PCR was carried out to analyze the expression of HDGF both in the cells (C) before the acquisition of irradiation resistance and in the cells (R15) after the acquisition of irradiation resistance. The results are shown in FIG. 3. As is clear from the expression pattern of HDGF shown in FIG. 3, the expression of HDGF was reduced in the cells (R15) after the acquisition of irradiation resistance, just as with the expression pattern of RSG1. Thus, from the above description, HDGF was identified as a gene, which has an expression level reduced by the acquisition of irradiation resistance.

### Example 4

Relationship Between Irradiation Resistance and Expression Level of HDGF Gene

The relationship between irradiation resistance and the expression level of the HDGF gene was analyzed by the Northern Blotting and the RT-PCR methods. The preparation of total RNA from each cell was carried out by the guanidine thiocyanate method. Fifty μg of the obtained total RNA was treated with 1 unit of DnaseI. Then, the DnaseI-treated total RNA was dissolved in diethyl pyrocarbonate-treated water so that the concentration is set at 1.0 μg/μl, and the mixture was subjected to the Northern Blotting and the RT-PCR.

The Northern Blotting was carried out as follows. Initially, 15 μg of total RNA was loaded onto 1.2% agarose-formamide gel, and then electrophoresed for 7 hours. Then, the electrophoresed RNA was transferred from the gel to a nylon membrane (Hybond-N+; Amersham Pharmacia Biotech). The membrane was UV cross-linked at a light intensity of 120,000 mJ/cm² using a UV irradiator (UV Stratalinker 1800; Stragagene). After each probe (a labeled probe for detection of HDGF or labeled probe for detection of GAPDH) was hybridized with the membrane at 42° C. overnight, the membrane was washed under appropriate stringency, and autoradiography was then performed.

The RT-PCR was carried out as follows. Initially, cDNA was synthesized from 8 μg of total RNA. Using the obtained cDNA as a template, PCR was carried out. The following conditions were applied for the PCR. The PCR conditions for HDGF was 94° C., 1 minute, 59° C., 1 minute, and 72° C., 1 minute for 24 cycles, and the conditions for bFGF was 94° C., 1 minute, 54° C., 1 minute, and 72° C., 1 minute for 26 cycles.

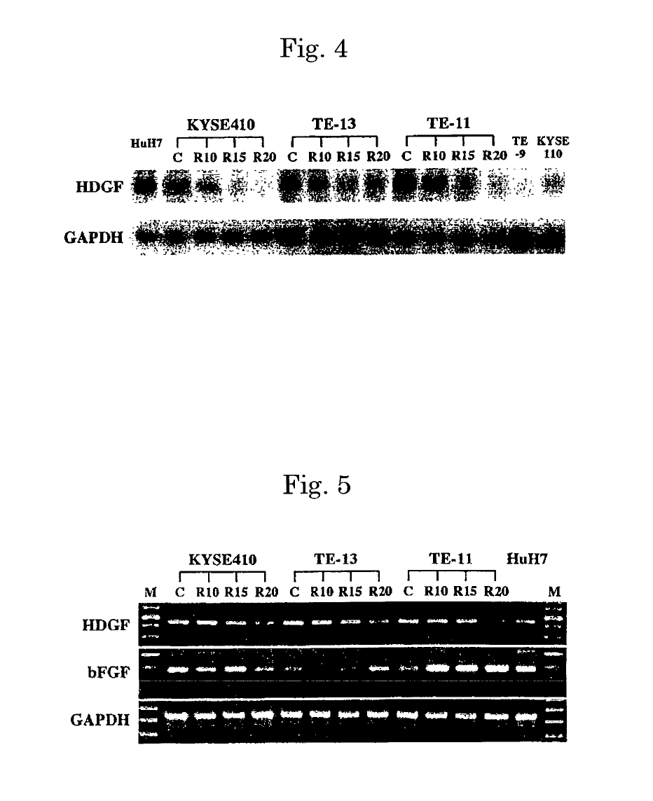

The results of the Northern Blotting are shown in FIG. 4, and the results of the RT-PCR are shown in FIG. 5. In both views, C represents a control cell line which was not treated by X-ray irradiation, and R10, R15 and P20 represent cell lines which were treated by 2 Gy of X-ray irradiation 10 times, 15 times and 20 times, respectively. As shown in FIG. 4, in all of KYSE410, TE-13 and TE-11, as the number of X-ray irradiation treatments increased, the mRNA expression level of HDGF decreased. Moreover, as shown in FIG. 5, the same results were obtained from the RT-PCR. Furthermore, as shown in FIG. 5, with regard to bFGF, apparent association was not found between the expression level and the number of X-ray irradiation treatment.

### Example 5

Effectiveness of Radiotherapy and Expression of HDGF in Clinical Cases

Using pathologic samples derived from squamous esophageal cancer patients, the association between the effectiveness of radiotherapy and the expression of HDGF was analyzed. As pathologic samples, there were used biopsy specimens enucleated from 25 esophageal cancer patients at the Medical Institute of Bioregulation, Kyusyu University, and at the Saitama Prefectural Cancer Center from year 1999 to 2000. All the 25 patients were male, and the mean age was 61.6 years. After obtaining informed consent from the patients, two or three biopsy specimens were enucleated. All the 25 patients were diagnosed as squamous cell carcinoma, and the patients underwent radiotherapy with a daily dose of 2 Gy, 5 days/week for 4 weeks before surgical resection. The effectiveness of radiotherapy in the resected specimens was determined using the histopathological criteria of the Japanese Society for Esophageal Diseases. For the expression analysis of HDGF mRNA, 10 to 40 μg of total RNA was extracted from the biopsy specimen of each patient before treatment with radiotherapy, and cDNA was synthesized from 2.5 μg of total RNA.

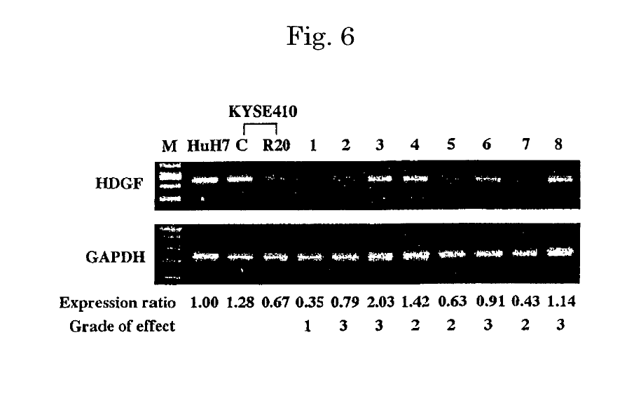

The semiquantitative RT-PCR was carried out on biopsy specimens obtained from 25 cases of squamous esophageal cancer cells, so as to assay the expression of HDGF mRNA before treatment with radiotherapy. The results are shown in FIG. 6. With regard to the HDGF GAPDH expression ratio, 1 denotes the ratio in a control cell line HuH-7. Under this condition, in the case of KYSE410, the HDGF:GAPDH ratio was 1.28 in control cell lines and 0.67 in the cell lines treated 20 times by 2 Gy of X-ray irradiation. Consequently, the association between HDGF expression and sensitivity to irradiation was confirmed. In clinical cases, the average ratio was 1.63±2.02 and the median was 1.14. When setting 1.14 as a boundary value, there was a significant difference between high (ratio>1.14) and low (<1.14) HDGF expression groups with respect to the histopathological grade. The histopathological grade was determined according to the histopathological criteria for the effectiveness of radiotherapy. Grade 0 represents the state where no radiotherapy effect is shown, Grade 1 represents the state where radiotherapy is slightly effective (about one third or more viable cancer cells are recognized), Grade 2 represents the state where radiotherapy is moderately effective (about one third or less viable cancer cells are recognized), and Grade 3 represents the state where radiotherapy is remarkably effective (no viable cancer cells are recognized). Table 2 shows the relationship between the effectiveness of radiotherapy for 25 esophageal cancer patients and the HDGF GAPDH ratio.

TABLE 2

Expression ratio of
HDGF

| | <1.14 | >1.14 | |
|---|---|---|---|
| | (n = 12) | (n = 13) | P |
| Histopathological grade | | | 0.047 |
| Grade 0 or 1 | 6 | 1 | |
| Grade 2 | 2 | 2 | |
| Grade 3 | 4 | 10 | |

As shown in Table 2, 10 patients out of 13 patients belonging to a group (HDGF:GAPDH ratio>1.14), which showed high HDGF expression before treatment with radiotherapy, had a significant effect of radiotherapy. From the above results, it was found that the HDGF expression level is effective as an index for previously determining the effectiveness of radiotherapy for cancer (especially esophageal cancer) patients.

### Effect of the Invention

According to the present invention, it becomes possible to predict the effect of radiotherapy for a cancer patient before treatment, and this is useful for the clinical application of a tailor-made treatment for cancer.

Sequence Listing Free Text

SEQ ID NO: 5 Synthetic DNA

SEQ ID NO: 6 Synthetic DNA

SEQ ID NO: 7 Synthetic DNA

SEQ ID NO: 8 Synthetic DNA

What is claimed is:

1. A method of predicting the effectiveness of radiotherapy for cancer patients, which comprises the steps of:
(a) performing a biopsy to collect cancer cells or cancer tissues from a cancer patient,
(b) determining the expression level of hepatoma derived growth factor (HDGF) in the cancer cells or cancer tissues obtained in step (a), and
(c) on the basis of the results obtained by the determination in step (b), predicting whether or not a significant treatment effect can be obtained when radiotherapy is carried out on said cancer patient.

2. The method of predicting the effectiveness of radiotherapy for cancer patients according to claim 1, wherein the prediction as to whether or not a significant treatment effect can be obtained when radiotherapy is carried out on a cancer patient is performed on the basis of the prediction standard that a significant treatment effect can be obtained when the expression level of hepatoma derived growth factor (HDGF) is high, but a significant treatment effect cannot be obtained when the expression level is low.

3. The method of predicting the effectiveness of radiotherapy for cancer patients according to claim 1, wherein the determination of the expression level is carried out at mRNA level or protein level.

4. The method of predicting the effectiveness of radiotherapy for cancer patients according to claim 1, wherein the determination of the expression level is carried out using a DNA chip or protein chip.

5. The method of predicting the effectiveness of radiotherapy for cancer patients according to claim 1, wherein the hepatoma derived growth factor (HDGF) is represented by the amino acid sequence of SEQ ID NO: 2 or encoded by DNA represented by the nucleotide sequence of SEQ ID NO: 1.

6. The method of predicting the effectiveness of radiotherapy for cancer patients according to claim 1, wherein the cancer patient is an esophageal cancer patient.

7. A method of predicting the effectiveness of radiotherapy for cancer patients, which further comprises a step of determining the expression level of a housekeeping gene or housekeeping protein in addition to the steps described in claim 1, and predicts whether or not a significant treatment effect can be obtained when radiotherapy is carried out on a cancer patient on the basis of the relative ratio of the mRNA level of an HDGF gene to the mRNA level of the housekeeping gene or the relative ratio of the protein level of HDGF protein to the protein level of the housekeeping protein, which is calculated based on the results obtained by the determination.

8. The method of predicting the effectiveness of radiotherapy for cancer patients according to claim 7, wherein the housekeeping gene or protein is a glyceraldehyde-3-phosphate dehydrogenase (GAPDH) gene or protein.

9. The method of predicting the effectiveness of radiotherapy for cancer patients according to claim 8, wherein the prediction as to whether or not a significant treatment effect can be obtained when radiotherapy is carried out on a cancer patient is performed on the basis of the prediction standard that a significant treatment effect can be obtained when the mRNA level of the HDGF gene/the mRNA level of the GAPDH gene is higher than 1.14, but a significant treatment effect cannot be obtained when the mRNA level of the HDGF gene/the mRNA level of the GAPDH gene is lower than 1.14.

10. A reagent used for predicting the effectiveness of radiotherapy for cancer patients, which comprises, as a functional ingredient, polynucleotide, oligonucleotide or a derivative thereof, which hybridizes with the mRNA of hepatoma derived growth factor (HDGF) under stringent conditions.

11. A reagent used for predicting the effectiveness of radiotherapy for cancer patients, which comprises, as a functional ingredient, an antibody against hepatoma derived growth factor (HDGF).

12. A kit used for predicting the effectiveness of radiotherapy for cancer patients, which comprises, as a main component, the prediction reagent according to claim 10 and/or claim 11.

13. A DNA chip used for predicting the effectiveness of radiotherapy for cancer patients, which is obtained by immobilizing polynucleotide or oligonucleotide, which hybridizes with the mRNA of hepatoma derived growth factor (HDGF) or a complementary strand thereof under stringent conditions.

14. A protein chip used for predicting the effectiveness of radiotherapy for cancer patients, which is obtained by immobilizing an antibody against hepatoma derived growth factor (HDGF).

15. A method of screening a compound enhancing a treatment effect when radiotherapy is carried out on a cancer patient, said screening method comprising a step of evaluating whether or not the expression level of hepatoma derived growth factor (HDGF) in a human cell is increased by addition of a candidate compound, wherein the activity of enhancing said expression level is the index of a candidate compound which can be an enhancer for the effectiveness of radiotherapy.


SEQUENCE LISTING (8 sequences)

SEQ ID NO: 1 - DNA, 723 bp, Homo sapiens
  CDS (1)..(723)
atgtcgcgatccaaccggcagaaggagtacaaatgcggggacctggtgttcgccaagatgaagggctacccacactggccggcccggattgacgagatgcctgaggctgccgtgaaatcaacagccaacaaataccaagtcttttttttcgggacccacgagacggcattcctgggccccaaagacctcttcccttacgaggaatccaaggagaagtttggcaagcccaacaagaggaaagggttcagcgaggggctgtgggagatcgagaacaaccctactgtcaaggcttccggctatcagtcctcccagaaaaagagctgtgtggaagagcctgaaccagagcccgaagctgcagagggtgacggtgataagaaggggaatgcagagggcagcagcgacgaggaagggaagctggtcattgatgagccagccaaggagaagaacgagaaaggagcgttgaagaggagagcaggggacttgctggaggactctcctaaacgtcccaaggaggcagaaaaccctgaaggagaggagaaggaggcagccaccttggaggttgagaggccccttcctatggaggtggaaaagaatagcaccccctctgagcccggctctggccgggggcctccccaagaggaagaagaagaggaggatgaagaggaagaggctaccaaggaagatgctgaggccccaggcatcagagatcatgagagcctgtag

SEQ ID NO: 2 - protein, 240 aa, Homo sapiens
MSRSNRQKEYKCGDLVFAKMKGYPHWPARIDEMPEAAVKSTANKYQVFFFGTHETAFLGPKDLFPYEESKEKFGKPNKRKGFSEGLWEIENNPTVKASGYQSSQKKSCVEEPEPEPEAAEGDGDKKGNAEGSSDEEGKLVIDEPAKEKNEKGALKRRAGDLLEDSPKRPKEAENPEGEEKEAATLEVERPLPMEVEKNSTPSEPGSGRGPPQEEEEEEDEEEEATKEDAEAPGIRDHESL

SEQ ID NO: 3 - DNA, 2376 bp, Homo sapiens
  CDS (316)..(1038)
gaggaggagtggggaccgggcggggggtggaggaagaggcctcgcgcagaggagggagcaattgaatttcaaacacaaacaactcgacgagcgcgcacccaccgcgccggagccttgccccgatccgcgcccgccccgtccgtgcggcgcgcgggcggagacgccgtggccgcgccggagctcgggccgggggccaccatcgaggcgggggccgcgcgagggccggagcggagcggcgccgccaccgccgcacgcgcaaacttgggctcgcgcttcccggcccggcgcggagcccggggcgcccggagccccgccatgtcgcgatccaaccggcagaaggagtacaaatgcggggacctggtgttcgccaagatgaagggctacccacactggccggcccggattgacgagatgcctgaggctgccgtgaaatcaacagccaacaaataccaagtcttttttttcgggacccacgagacggcattcctgggccccaaagacctcttcccttacgaggaatccaaggagaagtttggcaagcccaacaagaggaaagggttcagcgaggggctgtgggagatcgagaacaaccctactgtcaaggcttccggctatcagtcctcccagaaaaagagctgtgtggaagagcctgaaccagagcccgaagctgcagagggtgacggtgataagaaggggaatgcagagggcagcagcgacgaggaagggaagctggtcattgatgagccagccaaggagaagaacgagaaaggagcgttgaagaggagagcaggggacttgctggaggactctcctaaacgtcccaaggaggcagaaaaccctgaaggagaggagaaggaggcagccaccttggaggttgagaggccccttcctatggaggtggaaaagaatagcaccccctctgagcccggctctggccgggggcctccccaagaggaagaagaagaggaggatgaagaggaagaggctaccaaggaagatgctgaggccccaggcatcagagatcatgagagcctgtagccaccaatgtttcaagaggagcccccaccctgttcctgctgctgtctgggtgctactggggaaactggccatggcctgcaaactgggaacccctttcccaccccaacctgctctcctcttctactcacttttcccactccaagcccagcccatggagattgacctggatggggcaggccacctggctctcacctctaggtccccatactcctatgatctgagtcagagccatgtcttctccctggaatgagttgaggccactgtgttccttccgcttggagctattttccaggcttctgctggggcctgggacaactgctcccacctcctgacacccttctcccactctcctaggcattctggacctctgggttgggatcaggggtaggaatggaaggatggagcatcaacagcagggtgggcttgtggggcctgggaggggcaatcctcaaatgcggggtgggggcagcacaggagggcggcctccttctgagctcctgtcccctgctacacctattatcccagctgcctagattcagggaaagtgggacagcttgtaggggaggggctcctttccataaatccttgatgattgacaacacccatttttccttttgccgaccccaagagttttgggagttgtagttaatcatcaagagaatttggggcttccaagttgttcgggccaaggacctgagacctgaagggttgactttacccatttgggtgggagtgttgagcatctgtccccctttagatctctgaagccacaaataggatgcttgggaagactcctagctgtcctttttcctctccacacagtgctcaaggccagcttatagtcatatatatcacccagacataaaggaaaagacacattttttaggaaatgtttttaataaaagaaaattacaaaaaaaaattttaaagacccctaaccctttgtgtgctctccattctgctccttccccatcgttgcccccatttctgaggtgcactgggaggctccccttctatttggggcttgatgactttctttttgtagctggggctttgatgttccttccagtgtcatttctcatccacataccctgacctggccccctcagtgttgtcaccagatctgatttgtaacccactgagaggacagagagaaataagtgccctctcccaccctcttcctactggtctctctatgcctctctacagtctcgtctcttttaccctggcccctctcccttgggctctgatgaaaaattgctgactgtagctttggaagtttagctctgagaaccgtagatgatttcagttctaggaaaataaaacccgttgattact

SEQ ID NO: 4 - DNA, 230 bp, Homo sapiens
gtgctctccattctgctccttccccatcgttgcccccatttctgaggtgcactgggaggctccccttctatttggggcttgatgactttctttttgtagctggggctttgatgttccttccagtgtcatttctcatccacataccctgacctggccccctcagtgttgtcaccagatctgatttgtaacccactgagaggacagagagaaataagtgccctctcccaccc

SEQ ID NO: 5 - DNA, 22 bp, Artificial Sequence
  Description of Artificial Sequence synthetic DNA
cttctatttggggcttgatgac

SEQ ID NO: 6 - DNA, 22 bp, Artificial Sequence
  Description of Artificial Sequence synthetic DNA
gcacttatttctctcggtcctc

SEQ ID NO: 7 - DNA, 20 bp, Artificial Sequence
  Description of Artificial Sequence synthetic DNA
ctgaagccacaaataggatg

SEQ ID NO: 8 - DNA, 20 bp, Artificial Sequence
  Description of Artificial Sequence synthetic DNA
gggtaaaagagacgagactg